(19) United States
(12) Patent Application Publication
(10) Pub. No.: US 2026/0219726 A1
(43) Pub. Date: Jul. 30, 2026

(54) INFORMATION PROCESSING APPARATUS, INFORMATION PROCESSING METHOD, AND PROGRAM

(71) Applicant: SONY GROUP CORPORATION, TOKYO (JP)

(72) Inventors: YASUHIDE HOSODA, TOKYO (JP); RYU AOYAMA, TOKYO (JP); IZUMI YAGI, TOKYO (JP); YUSUKE SAKAI, TOKYO (JP); RYUSEI KOIKE, TOKYO (JP); HIROYUKI OSHIMA, TOKYO (JP)

(21) Appl. No.: 19/146,520

(22) PCT Filed: Dec. 28, 2023
(86) PCT No.: PCT/JP2023/047203

§ 371 Date: Jul. 8, 2025

(30) Foreign Application Priority Data
Jan. 12, 2023 (JP) 2023-003069

(51) Int. Cl. G06F 3/01

(52) U.S. Cl. CPC G06F 3/011

(57) ABSTRACT

The present technology relates to an information processing apparatus, an information processing method, and a program that make it possible to make a user feel that the use of services is a special occasion. An information processing apparatus according to an aspect of the present technology is an apparatus that determines a state of a user on the basis of sensor data acquired using a sensor situated around the user; and that provides the user with a specific service for which content is used, the provision being performed when the user is alone at a specific location surrounded by wall surfaces in at least three directions. Content that includes sound and an image is used for services, where examples of the content include content that offers a state in which a user is surrounded by his/her favorites, and content that offers a state in which the user is alone. The present technology can be applied to smartphones.

### TECHNICAL FIELD

The present technology relates to an information processing apparatus, an information processing method, and a program, and, in particular, to an information processing apparatus, an information processing method, and a program that make it possible to make a user feel that the use of services is a special occasion.

### BACKGROUND ART

Various services available in virtual spaces are provided. For example, a user can communicate with other people using avatars and enjoy shopping in a shop in a virtual space.

When a user uses such services by use of, for example, a smartphone, the user can use the services regardless of location, that is, regardless of whether the location is home or the place where the user has gone to. Further, the user can use the services regardless of which time period it is.

### CITATION LIST

### Patent Literature

Patent Literature 1: Japanese Patent Application Laid-open No. 2016-021091

### DISCLOSURE OF INVENTION

### Technical Problem

A context with respect to a user is less likely to be considered when the user uses services. The advantage of being available anywhere at any time may result in losing preciousness of the use of services.

The present technology has been made in view of the circumstances described above, and it is an object of the present technology to make it possible to make a user feel that the use of services is a special occasion.

Solution to Problem

An information processing apparatus according to an aspect of the present technology includes a controller that determines a state of a user on the basis of sensor data acquired using a sensor situated around the user; and that provides the user with a specific service for which content is used, the provision being performed when the user is alone at a specific location surrounded by wall surfaces in at least three directions.

In the aspect of the present technology, a state of a user is determined on the basis of sensor data acquired using a sensor situated around the user; and the user is provided with a specific service for which content is used, the provision being performed when the user is alone at a location surrounded by wall surfaces in at least three directions.

### BRIEF DESCRIPTION OF DRAWINGS

FIG. 1 illustrates how services are provided in an information processing system according to an embodiment of the present technology.

FIG. 2 illustrates examples of available services.

FIG. 3 illustrates examples of UI screens for content.

FIG. 4 illustrates examples of locations at which services are available.

FIG. 5 is a block diagram of an example of a configuration of the information processing system.

FIG. 6 is a diagram of a sequence used to describe a series of processes performed in the information processing system.

FIG. 7 is a diagram of a sequence used to describe a trigger condition determining process performed in Step S13 of FIG. 6.

FIG. 8 illustrates an example of detecting an echoing sound.

FIG. 9 is a block diagram of another example of the configuration of the information processing system.

FIG. 10 is a block diagram of another example of the configuration of the information processing system.

FIG. 11 illustrates an example of disclosing information.

FIG. 12 is a diagram of a sequence used to describe how processing of issuing an NFT is performed.

FIG. 13 is a diagram of a sequence used to describe how primary processing is performed on the day of an event.

FIG. 14 illustrates an example of application to the case in which a real item is delivered.

FIG. 15 is a block diagram of an example of a configuration of a user terminal.

FIG. 16 is a block diagram of an example of a configuration of an information processing server.

FIG. 17 is a block diagram of an example of a configuration of a service providing server.

### MODE(S) FOR CARRYING OUT THE INVENTION

Embodiments for carrying out the present technology are described below. The description is made in the following order.
1. System in Which Services are Available Only When Specific Conditions are Satisfied
2. Provision of Services Related to Specific Event
3. Configuration of Each Apparatus
4. Modifications

### System in Which Services are Available Only When Specific Conditions are Satisfied

### Conditions for Using Services

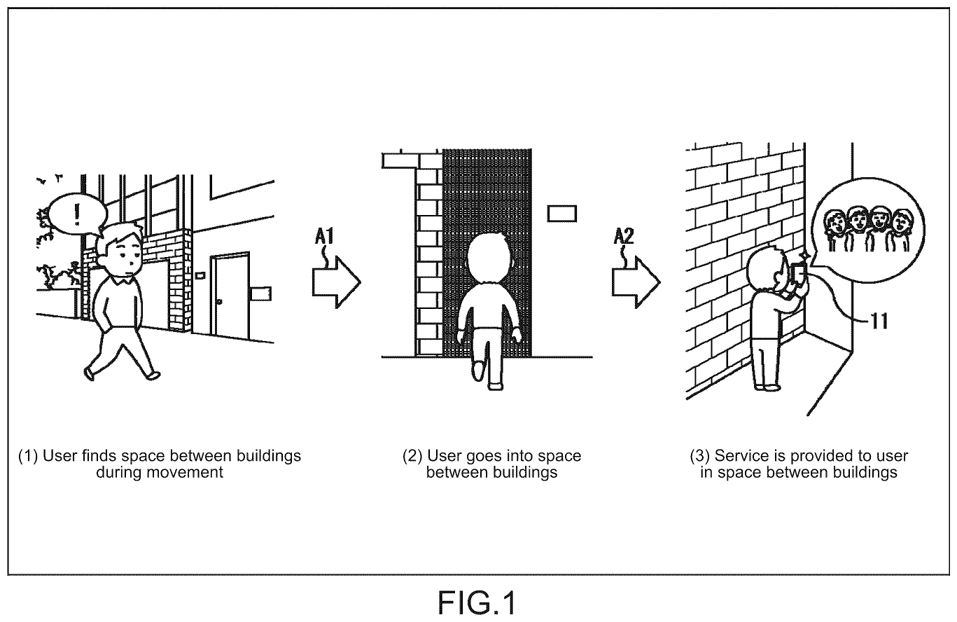

FIG. 1 illustrates how services are provided in an information processing system according to an embodiment of the present technology.

In the information processing system according to the embodiment of the present technology, a user can use services only when a state of (a context with respect to) the user satisfies specific conditions. The state of the user is detected, and it is repeatedly determined whether a specific condition is satisfied.

It is assumed that a user who is walking on the street finds a space between buildings that satisfies all of the conditions that enable the user to be provided with services, as illustrated on the left in FIG. 1. For example, the condition that a small space is surrounded by walls situated in three directions is set to be a location-related condition for using the services. Further, the condition that there is no one but the user nearby, that is, the condition that the user is alone is set to be a number-of-people-related condition for using the services.

The user wears earphones, and goes into the space between buildings alone, as indicated by an arrow A1. Accordingly, the user can use services, as indicated by an arrow A2. The services provided to the user in the space between buildings are services available by use of a user terminal 11 such as a smartphone. Content transmitted from a server on the Internet is output by the user terminal 11. Accordingly, the services are provided.

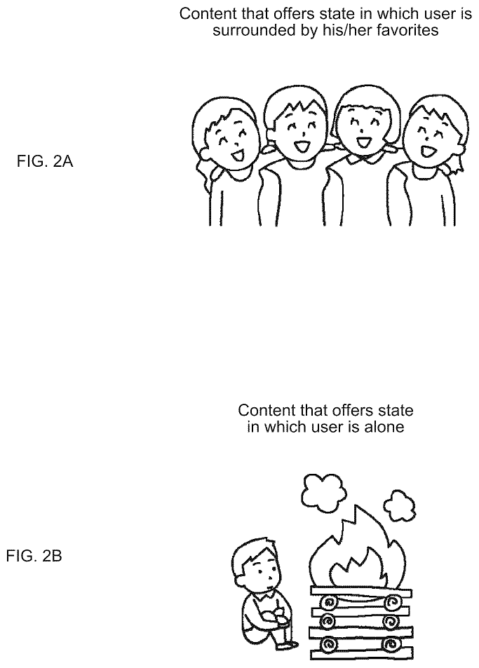

FIG. 2 illustrates examples of available services.

As illustrated in A and B of FIG. 2, content that offers a state in which a user is surrounded by his/her favorites and content that offers a state in which the user is alone are provided. When the user goes into a space between buildings alone, for example, a selection screen for selecting content is displayed on the user terminal 11, and favorite content is selected.

Each piece of content is a piece of content that includes at least one of sound data or image data including a video or a still image. An image of content is displayed on a display of the user terminal 11. Further, sound of content is output through a speaker of the user terminal 11 or through earphones worn by the user. Content different from the content illustrated in FIG. 2 may be provided.

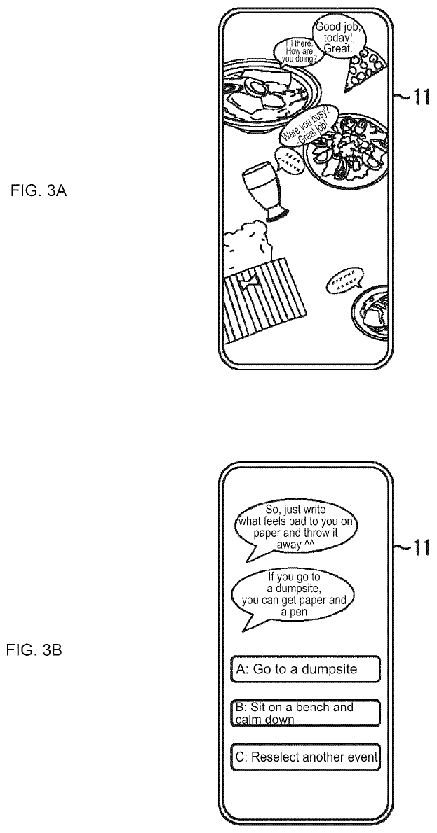

FIG. 3 illustrates examples of UI screens for content.

A of FIG. 3 illustrates a UI screen for content that offers a state in which a user is surrounded by his/her favorites. For example, content that offers the following state is provided: a video on which objects representing, for example, foods and drinks that are favorites of a user move in a virtual space, is displayed, and these objects talk to the user.

Content that presents various objects in a virtual space such as people including idols and actors in the virtual space; and products including automobiles and cameras in the virtual space may be provided as content that offers a state in which a user is surrounded by his/her favorites. When a user views a screen illustrated in A of FIG. 3 and hears sound or background music, this enables the user to feel healed by himself/herself.

A user may use an avatar that moves in a virtual space such that the user can communicate with an object provided as content.

B of FIG. 3 illustrates a UI screen for content that offers a state in which a user is alone. For example, a selection screen for selecting various pieces of content such as content used to organize negative memories (content of “going to a dumpsite”) is displayed. For example, the content for organizing negative memories is content for showing a user a state in which an object that represents a negative memory input by the user is being destroyed in a virtual space or content for showing the user a state in which data of a picture with memories is being deleted.

Setting may be performed such that content such as data of a picture with memories is not allowed to be used until the date and time set by a user, instead of deleting the content. The use of content selected on a screen illustrated in B of FIG. 3 enables a user to work off stress by himself/herself. Further, the user can maintain data with memories without a third party's knowledge.

As described above, the information processing system according to the embodiment of the present technology provides content used to cause a user to feel healed or content used to cause a user to work off stress. This allows, for example, the following story to be realized.

A user finishes a business trip in the morning and is scheduled to visit two more companies in the afternoon. The user is mentally tired, and thus wants to get refreshed to get through the remaining tasks.

On the way to the next job, the user finds a space between buildings that satisfies all of conditions. The user has sufficient time before the visit time for the next job. When the user wears earphones and goes into the space, the user hears gentle sound. Further, favorites of the user appear on a screen of the user terminal 11, where the screen displays thereon a state in a virtual space. The user forgets that he/she is now tired, and gets back energy to get through the remaining tasks.

The experience in using services can be made precious by asking a user to do an unusual behavior that includes looking for a location that satisfies a specific condition and entering the location alone, as described above. In other words, this makes it possible to make a user feel that the use of services is a special occasion. If the services are available anywhere at any time, this will result in difficulty in feeling the preciousness of the use of services. Such a situation can be prevented.

A user is provided with, for example, content that offers a state in which the user is surrounded by his/her favorites or content that offers a state in which the user is alone. This enables a small space surrounded by walls to make the user feel comfortable as if the user was in a break room or in a coffee room.

A user can experience content in a virtual space by going into a small space surrounded by walls. This makes it possible to make a user feel that the small space surrounded by walls is an entrance to a special world. This makes it possible to make a user to feel that the user is going to a special world.

The services are available only when a user is alone in a small space surrounded by walls. This makes it possible to prevent details of content from being seen by a person situated around the user, and this is also favorable in terms of security.

The location at which the services are available is not limited to a location that is a space between buildings, as described above. Various spaces surrounded by walls in at least three directions can be used as locations at which the services are available.

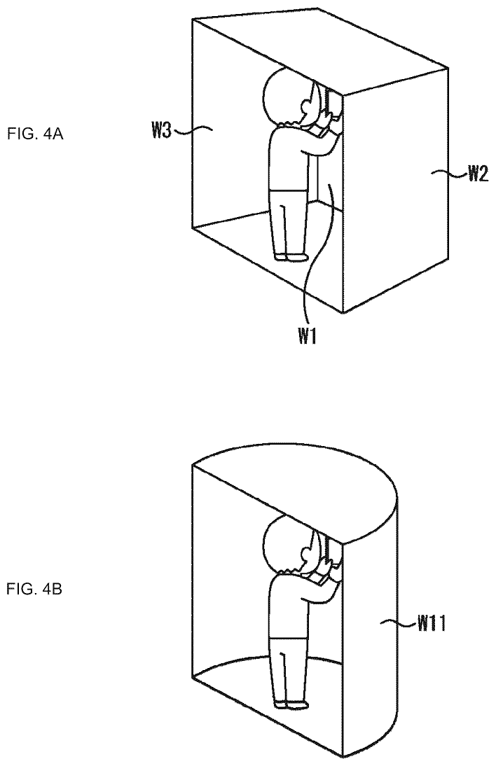

FIG. 4 illustrates examples of locations at which services are available.

As illustrated in FIG. 4, a location surrounded by walls in a direction of front of a user and in directions of right and left sides of the user is set to be a location at which services are available. Each of the locations illustrated in FIG. 4 is also surrounded by a planar member in a direction of an upper side of the user.

The location illustrated in A of FIG. 4 is a location surrounded by planar members in a direction of front of a user and in directions of right and left sides of the user. A wall surface in the front direction is formed using a member W1, and a wall surface in the right direction and a wall surface in the left direction are respectively formed using members W2 and W3. The wall surface formed using the member W2 is a wall surface that extends in a direction substantially orthogonal to the wall surface extending in the front direction and being formed using the member W1. The wall surface formed using the member W3 is a wall surface that faces the wall surface formed using the member W2.

The location illustrated in B of FIG. 4 is a location surrounded by a continuous curved member in a direction of front of a user and in directions of right and left sides of the user. A wall surface that extends in the front direction and wall surfaces that extend in the right and left directions are integrally formed using a curved member W11.

The setting of a condition that a user enters such a location alone also makes it possible to make a user feel that the use of services is a special occasion. A space as illustrated in FIG. 4 may be provided at various locations such as a station yard, commercial facilities, and home. A display and a speaker that are used to output content may be provided in the space.

A location that satisfies a condition for being provided with services is hereinafter referred to as a trigger point as appropriate, which means that the location serves as a trigger used to use the services. A user can use the services when he/she is alone at a trigger point.

### System Configuration

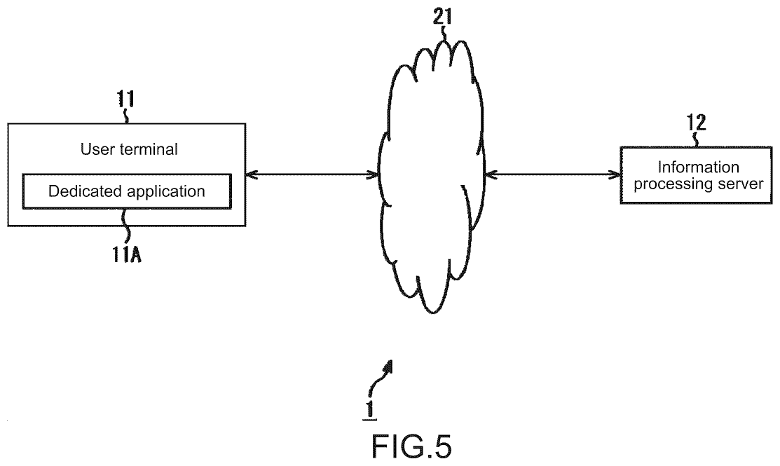

FIG. 5 is a block diagram of an example of a configuration of an information processing system 1 according to the embodiment of the present technology.

As illustrated in FIG. 5, the information processing system 1 is configured by the user terminal 11 and an information processing server 12 being connected to each other through a network 21 such as the Internet. FIG. 5 only illustrates one user terminal used by a certain user. However, much more user terminals are provided to the information processing system 1.

The user terminal 11 is an information processing apparatus such as a smartphone, a tablet, a smartwatch, or smart glasses. The user terminal 11 is carried by a user who intends to use services in the information processing system 1. A dedicated application 11A used to use the services is installed on the user terminal 11.

The dedicated application 11A maintains information, such as a user ID and a password, that is identification information regarding a user in the information processing system 1. When the user intends to use services, it is necessary for the user to perform a user registration including setting, for example, a user ID and a password.

During running of the dedicated application 11A, the user terminal 11 acquires sensor data that indicates a result of detection performed by a sensor situated around a user, and transmits the acquired sensor data to the information processing server 12, where examples of the sensor situated around the user include a sensor included in the user terminal 11 and a sensor worn by the user. For example, various sensors such as a camera, a mike (a microphone), a ToF sensor, and a biological sensor are provided to the user terminal 11.

The sensor data indicating a surrounding environment around a user is transmitted repeatedly during running of the dedicated application 11A. The information processing server 12 determines whether a condition for using a service is satisfied on the basis of the sensor data transmitted by the user terminal 11.

When it has been determined that the condition for using the service is satisfied, the user terminal 11 receives content transmitted by the information processing server 12, and outputs the content by displaying a UI screen and outputting sound. When it has been determined that the condition for using the service is satisfied, the information processing server 12 transmits content related to the service to the user terminal 11. As described later, the user terminal 11 may determine whether the condition for using the service is satisfied.

The information processing server 12 is an information processing apparatus managed by an operator that provides services using the information processing system 1.

The information processing server 12 receives information transmitted by the user terminal 11, and determines whether the condition for using the service is satisfied. When the information processing server 12 has determined that the condition for using the service is satisfied, the information processing server 12 transmits content to the user terminal 11 to provide the service. For each service provided by the information processing server 12, there is content related to the service.

As described above, the information processing server 12 is an information processing apparatus that determines whether a user satisfies a condition for using a service, and that provides the service to a user who satisfies the condition. The information processing server 12 provides services through the user terminal 11.

On the other hand, when the user terminal 11 determines whether a user satisfies a condition for using a service, the user terminal 11 is an information processing apparatus that determines whether a user satisfies a condition for using a service, and that provides the service directly to a user who satisfies the condition.

Configurations of the user terminal 11 and the information processing server 12 will be described in detail later.

### How Processes are Performed in Information Processing System 1

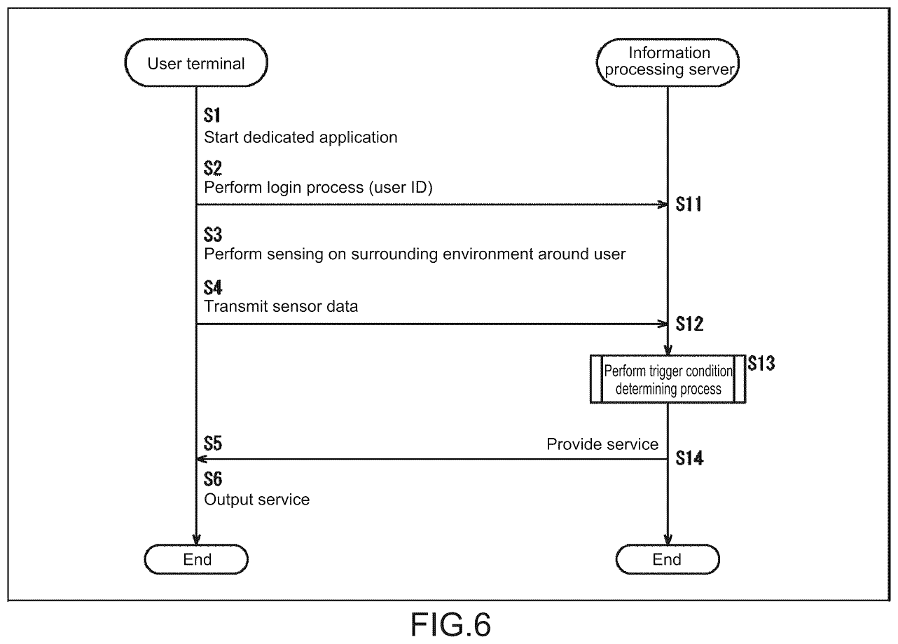

Here, a series of processes performed in the information processing system 1 until services are provided is described with reference to a sequence illustrated in FIG. 6.

In Step S1, the user terminal 11 starts the dedicated application 11A in response to, for example, an operation being performed by a user. Subsequent processes performed by the user terminal 11 are processes performed using functions of the dedicated application 11A.

In Step S2, the user terminal 11 performs a login process by, for example, transmitting a user ID and a password to the information processing server 12.

In Step S11, the information processing server 12 receives the user ID and password transmitted by the user terminal 11, and authenticates the user. When the authentication is successful, subsequent processes are performed.

In Step S3, the user terminal 11 performs sensing on a surrounding environment around the user to acquire sensor data. The user terminal 11 acquires sensor data detected using a sensor situated around the user, where examples of the sensor situated around the user include a sensor included in the user terminal 11 and a sensor included in a device worn by the user.

In Step S4, the user terminal 11 transmits the sensor data indicating the surrounding environment around the user to the information processing server 12.

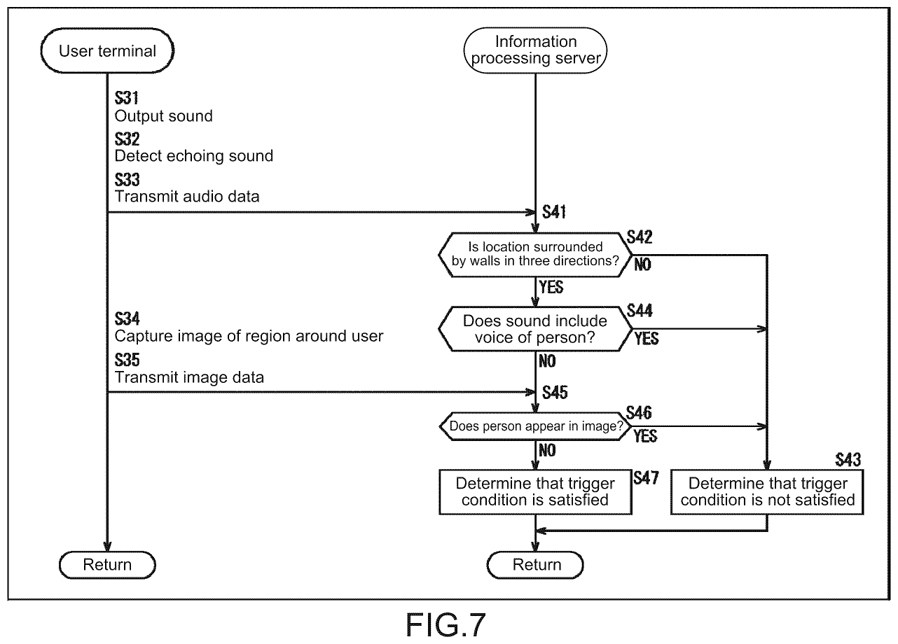

The information processing server 12 receives, in Step S12, the sensor data transmitted by the user terminal 11, and performs a trigger condition determining process in Step S13. The trigger condition determining process is a process of determining whether a trigger condition that is a condition for using a service is satisfied. The trigger condition determining process will be described later with reference to a sequence illustrated in FIG. 7. Subsequent processes are processes performed when it is determined, as a result of the trigger condition determining process, that the condition for using the service is satisfied.

In Step S14, the information processing server 12 provides the service to the user by transmitting content to the user terminal 11. Content related to the service is transmitted to the user terminal 11.

The user terminal 11 receives, in Step S5, the content transmitted by the information processing server 12, and outputs the received content in Step S6. Accordingly, the user having been determined to satisfy the condition for using the service can use the service alone.

Next, the trigger condition determining process performed in Step S13 of FIG. 6 is described with reference to the sequence illustrated in FIG. 7. For convenience of description, FIG. 7 also illustrates, for example, processing performed by the user terminal 11 to perform sensing on a surrounding environment around a user (processing corresponding to the processes of Steps S3 and S4 of FIG. 6).

The user terminal 11 outputs sound at a specified volume through a speaker in Step S31, and detects an echoing sound through a mike in Step S32.

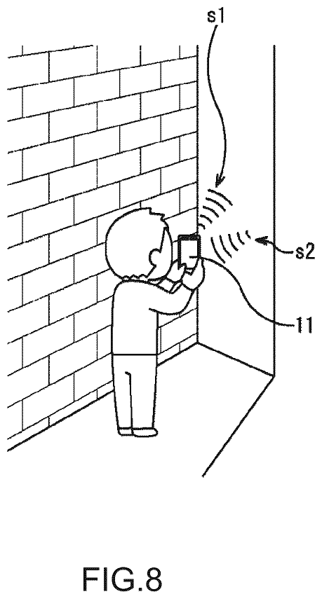

FIG. 8 illustrates an example of detecting an echoing sound.

The user terminal 11 includes, for example, a directional speaker with which sound can be output in each direction. Further, the user terminal 11 includes a directional mike with which sound from each direction can be detected. As illustrated in FIG. 8, an echoing sound s2 of sound s1 output through the speaker is detected using the mike.

In the example illustrated in FIG. 8, an echoing sound that is output in a front direction and reflected off a wall surface situated in the front direction is detected. A surrounding environment around a user can be specified on the basis of an echoing sound coming from a direction that corresponds to a direction of the directivity of the speaker.

In this example, it is determined, on the basis of characteristics of an echoing sound, whether a user is at a trigger point. The speaker used to output sound and the mike used to detect an echoing sound may be provided to be external to the user terminal 11.

Returning to the description of FIG. 7, in Step S33, the user terminal 11 transmits, to the information processing server 12, audio data of an echoing sound detected using the mike. Not only audio data of an echoing sound of sound output through the speaker but also audio data of a surrounding environmental sound is transmitted to the information processing server 12.

In Step S34, the user terminal 11 controls the camera to capture an image of a region around the user, and transmits image data of the image obtained by the image-capturing to the information processing server 12 in Step S35. For example, image data of an image obtained by image-capturing being performed in each direction, and image data of a wide-angle image captured such that each direction is in an angle of view are transmitted to the information processing server 12.

In Step S41, the information processing server 12 receives audio data transmitted by the user terminal 11, and in Step S42, the information processing server 12 determines whether the user is at a location surrounded by wall surfaces in three directions.

For example, when volume of an echoing sound of sound output in each of a front direction, a right direction, and a left direction is greater than or equal to a threshold volume or when a time taken until each of the echoing sounds is detected is shorter than a threshold time, it is determined that the user is at a location surrounded by wall surfaces in three directions, where the echoing sounds are from among echoing sounds of sounds output in the respective directions. The front direction of a user is detected using, for example, a gyroscope included in the user terminal 11.

When the volume of the echoing sound of the sound output in each of the front direction, the right direction, and the left direction is greater than or equal to the threshold volume and when the time taken until each of the echoing sounds is detected is shorter than the threshold time, it may be determined that the user is at a location surrounded by wall surfaces in three directions.

When the information processing server 12 has determined, in Step S42, that the user is not at the location surrounded by the wall surfaces in the three directions, the information processing server 12 determines, in Step S43, that the trigger condition is not satisfied. Thereafter, the processing is terminated.

On the other hand, when the information processing server 12 has determined, in Step S42, that the user is at the location surrounded by the wall surfaces in the three directions, the information processing server 12 determines, in Step S44, whether sound detected using the mike includes a voice of a person, on the basis of the audio data transmitted by the user terminal 11. For example, it may be determined whether detected sound includes a voice of a person, using a frequency of the sound (normally, a frequency of a voice of a person is from about 100 to 1000 Hz).

When the information processing server 12 has determined, in Step S44, that the voice of a person is included, the process moves on to Step S43, and it is determined that the trigger condition is not satisfied.

On the other hand, when the information processing server 12 has determined, in Step S44, that the voice of a person is not included, the information processing server 12 receives, in Step S45, image data transmitted by the user terminal 11.

In Step S46, the information processing server 12 determines whether a person other than the user appears in an image captured using the camera. The image captured using the camera is analyzed to perform a person recognition. The person recognition may be performed using a model created by machine learning.

In this example, it is determined whether a user is alone, on the basis of audio data and image data. In other words, it is determined the presence or absence of a voice of a person on the basis of audio data that indicates an echoing sound collected using a mike situated around the user, and it is determined the presence or absence of a person on the basis of image data of an image captured using a camera situated around the user. Accordingly, it is determined whether the user is alone.

It may be determined whether a user is alone, on the basis of only audio data or on the basis of only image data. It can be determined whether a user is alone, on the basis of at least one of audio data or image data.

When the information processing server 12 has determined, in Step S46, that a person other than the user appears in the image, the process moves on to Step S43, and the information processing server 12 determines that the trigger condition is not satisfied.

On the other hand, when the information processing server 12 has determined, in Step S46, that a person other than the user does not appear in the image, the information processing server 12 determines, in Step S47, that the trigger condition is satisfied. Thereafter, the process returns to Step S13 of FIG. 6, and the subsequent processes are performed on a user who satisfies the trigger condition.

It may be determined whether a user is at a location surrounded by wall surfaces in three directions, on the basis of a result of analyzing an image captured using a camera, or on the basis of a result of analyzing a range image obtained by detection performed using a ToF sensor.

It may be determined whether a user is alone, on the basis of a result of detection performed using a thermosensor, or on the basis of a result of analyzing a range image obtained by detection performed using a ToF sensor.

As described above, various methods may be adopted as the methods for determining whether a trigger condition is satisfied.

The determination of whether a trigger condition is satisfied is performed repeatedly. When the user goes out of the location surrounded by the wall surfaces in the three directions or when a person approaches the user who is using the service, the provision of the service is terminated.

According to the processing described above, services can be provided to only a user who is alone at a location with which a specific condition is satisfied, where examples of the location include a location surrounded by wall surfaces in three directions. This makes it possible to make the user feel that the use of the services is a special occasion.

### Provision of Services Related to Specific Event

The above-described function performed by the information processing system 1 to provide services to a user who satisfies a trigger condition can also be applied when a service related to an event held in a real space is provided. Different services are available for respective timings that are a timing before the event, a timing on the day of the event, and a timing after the event.

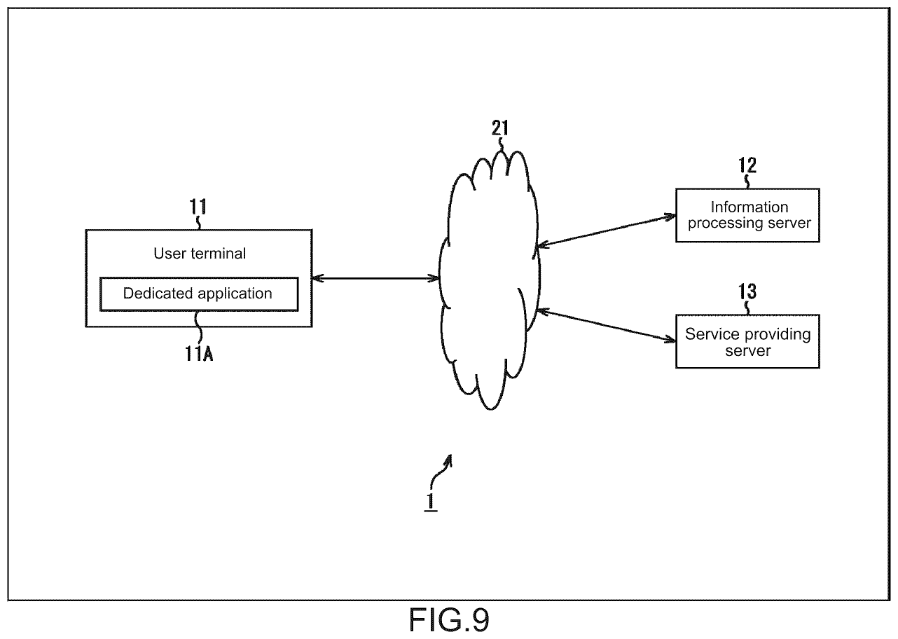

FIG. 9 is a block diagram of another example of the configuration of the information processing system 1. A structural element, from among structural elements illustrated in FIG. 9, that is the same as the structural element described with reference to FIG. 5 is denoted by the same reference numeral as the structural element described with reference to FIG. 5. A repetitive description is omitted as appropriate.

As illustrated in FIG. 9, a service providing server 13 that is a server that provides a service related to a specific event is provided to the information processing system 1. The service providing server 13 transmits content to the user terminal 11 of a user who satisfies a condition for using a service, and provides the service. In the example illustrated in FIG. 9, the information processing server 12 determines whether a trigger condition is satisfied, and transmits information indicating a result of the determination to the service providing server 13.

In the example illustrated in FIG. 9, there is only one service providing server 13. However, much more service providing servers 13 are connected to the network 21. For example, a server that provides a service related to each event is provided for each event separately from the information processing server 12.

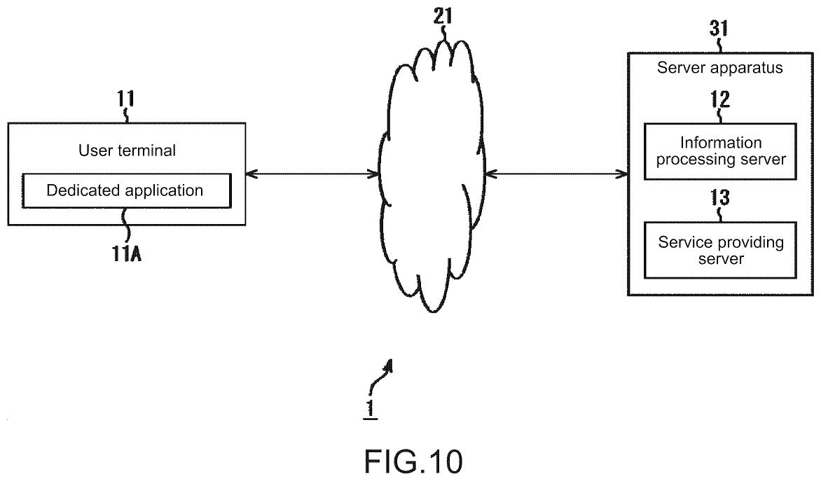

As illustrated in FIG. 10, the information processing server 12 and the service providing server 13 may be provided in one server apparatus 31. The server apparatus 31 is an apparatus that includes a function of the information processing server 12 and a function of the service providing server 13.

### Example of Application to Event That is “Concert”

Here, an example of application to the case in which a concert of a certain artist takes place as an event in a real space. For example, it is assumed that, before the day of an event, a user gets a concert ticket created in the form of a non-fungible token (NFT). The NFT, a non-fungible token, includes various concert-related information such as information regarding the user, the date and time of the concert, and a location of a concert hall. The NFT serving as the concert ticket has been already linked to the dedicated application 11A. The dedicated application 11A can refer to each piece of information included in the NFT.

### Before Event

When the user satisfies a trigger condition, for example, at home, the user is provided with a service that allows the user to purchase an item the user wants for preparing for the concert, the service corresponding to a service provided before the event. For example, the user uses the service by going into a small space in a user's room or at home. The user uses the service, and this enables the user to purchase items such as a penlight used in a concert hall and goods of a favorite (goods related to a person supported by the user).

Further, information regarding a set list is presented as the service provided before the event. The user can prepare for pieces of music to be played at the concert. A service with which a favorite of the user presents a countdown to the concert day, may be provided.

A state in which a trigger condition is satisfied means a state in which the user is alone. A service that allows the user to talk to his/her favorite face-to-face may be provided as the service provided before the event. By being provided with such services, the user can spend his/her days before the event while feeling healed by himself/herself.

### Day of Event

The NFT serving as the concert ticket includes information regarding a concert-related specific period of time, and information regarding a concert-related specific position. For example, the day of the concert is set to be the specific period of time, and an area near the concert hall is set to be the specific position.

When it is determined that the user is at the specific position for the specific period of time, information such as a user ID and a current position is transmitted to the service providing server 13 (is uploaded). For example, the NFT serving as the concert ticket also includes address information used to specify a transmission destination of the information such as a user ID and a current position. The service providing server 13 starts providing, for example, guidance that shows a route to the concert hall according to a current position of the user.

Further, guidance that guides the user to a trigger point set in the concert hall is started after the user arrives in the concert hall. In accordance with the guidance, the user moves to the trigger point to be alone. This results in providing a service that allows the user to purchase an item the user wants and to talk to his/her favorite. For example, a person printed on a real acrylic stand purchased in the hall appears in a virtual space, and the user can talk to the person.

A current state at a dressing room of an artist may be allowed to be seen live using a screen set in a virtual space. A plurality of trigger points may be set in a concert hall, and different services may be available at the respective trigger points.

While a user is using services, sensing may be performed with respect to a feeling of the user, and content may be controlled such that details of a talk with his/her favorite is changed according to the feeling of the user. For example, sensing with respect to the feeling of the user is performed on the basis of a facial expression of the user of which an image is captured using a camera, or on the basis of his/her heartbeat detected using a biological sensor. When the heartbeat exhibits a value greater than or equal to a threshold and the user is nervous, his/her favorite may give a special speech such as “Just relax” in a virtual space.

As described above, a user can also use, in a concert hall, services provided by the service providing server 13, and this enables the user to keep on feeling healed.

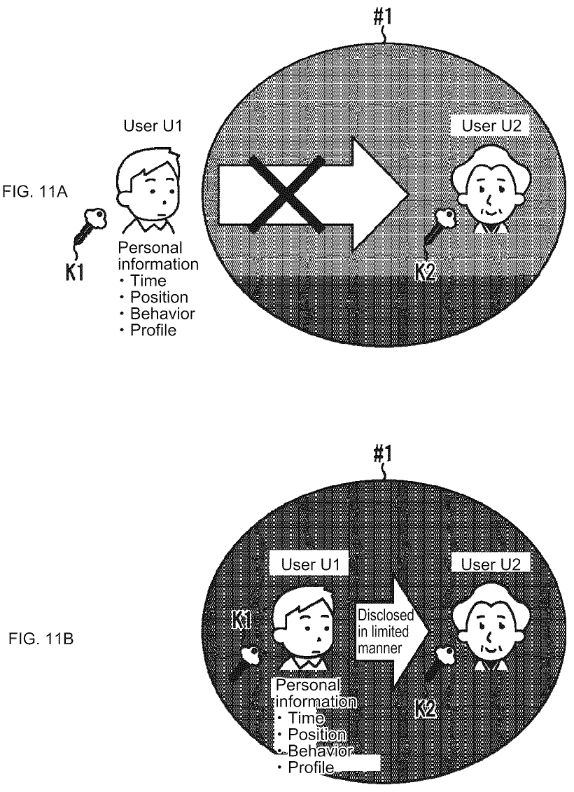

FIG. 11 illustrates an example of disclosing information.

When a user who is holding a key item related to an event in a real space is at a specific position such as an area near an event site for a specific period of time, personal information regarding the user is disclosed to another user who is holding the key item at the same specific position. For example, the service providing server 13 discloses the personal information. The key item may be a physical item such as a penlight, or an electronic item such as an NFT.

In the example illustrated in FIG. 11, there are a user U1 who is holding a key item K1, and a user U2 who is holding a key item K2. The user U1 has the user terminal 11. There are actually much more users at an event such as a concert.

A of FIG. 11 illustrates a state in which the user U2 is in an area #1 that corresponds to the specific position and the user U1 is outside of the area #1. The area #1 is, for example, an area set near the concert hall. In this case, personal information regarding the user U1 is not disclosed to the user U2.

On the other hand, when the user U1 goes into the area #1, the personal information regarding the user U1 is disclosed to the user U2, as illustrated in B of FIG. 11. The personal information such as a current position, details of a behavior, and a profile of the user U1 is disclosed together with information regarding a time, and the user U2 can view these pieces of information by operating his/her own user terminal.

Likewise, the user U1 can view information regarding the user U2 by operating the user terminal 11. For example, personal information regarding the user U2 is transmitted from the service providing server 13 to the user terminal 11 and displayed on a screen of the user terminal 11.

This results in creating a limited community in which there are limitations on a period of time and a position. In the limited community, users can communicate with each other smoothly. Further, the service providing server 13 can present appropriate information to each user on the basis of personal information regarding the user.

### After Event

When the user satisfies a trigger condition, for example, at home, a service that allows the user to be surrounded by stuff of memories of the concert is provided to the user as a service provided after the event. For example, goods purchased in the concert hall and pictures taken in the concert hall are displayed on the screen of the user terminal 11. The user can feel healed, as in the case of using content that offers a state in which the user is surrounded by his/her favorites, which has been described with reference to FIG. 2.

When it has been determined that the user is at a specific position such as an area near the concert hall, the same pieces of music as the set list of the concert may start being played. The NFT serving as the concert ticket also includes information regarding the specific position, as described above. When the same pieces of music as the set list start being played on the basis of audio data transmitted by the service providing server 13, this results in the user thinking back the concert.

### Sequence

A series of processes of providing services at a concert that is an event in a real space, is described.

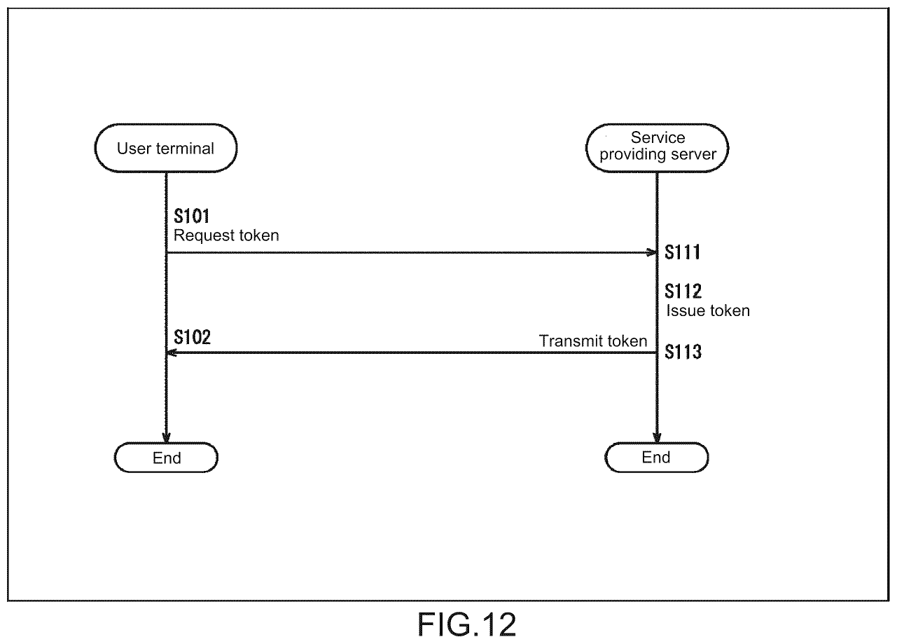

First, how processing of issuing an NFT that serves as a concert ticket is performed is described with reference to a sequence illustrated in FIG. 12. The processing illustrated in FIG. 12 starts being performed when, for example, a user operates the user terminal 11 and performs selection to purchase a specified NFT from a site for selling NFTs that serve as concert tickets.

In Step S101, the user terminal 11 makes a request that a token (an NFT) selected by a user be issued. Information indicating a request for issuance of an NFT is transmitted to, for example, the service providing server 13. In this example, an NFT is issued by the service providing server 13. However, the issuance may be performed by the information processing server 12 or by a server other than the information processing server 12 and the service providing server 13.

The service providing server 13 receives, in Step S111, the information transmitted by the user terminal 11, and issues (creates) the NFT in Step S112. The NFT issued by the service providing server 13 includes various information related to the concert together with information regarding the user such as a user ID.

In Step S113, the service providing server 13 transmits the issued NFT to the user terminal 11.

In Step S102, the user terminal 11 receives the NFT transmitted by the service providing server 13. Information regarding the NFT serving as the concert ticket can be checked on a screen of the dedicated application 11A.

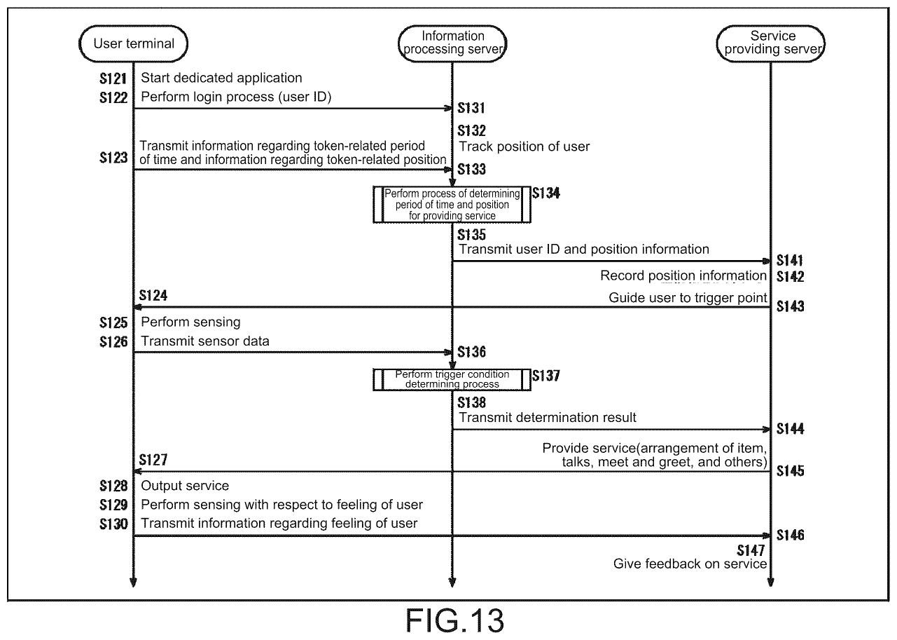

Next, how primary processing is performed on the day of an event is described with reference to a sequence illustrated in FIG. 13. When the description is repetition of what is described with reference to, for example, FIG. 6, the description is omitted as appropriate.

In Step S121, the user terminal 11 starts the dedicated application 11A in response to, for example, an operation being performed by a user. Subsequent processes performed by the user terminal 11 are processes performed using functions of the dedicated application 11A.

In Step S122, the user terminal 11 performs a login process by, for example, transmitting a user ID and a password to the information processing server 12.

In Step S131, the information processing server 12 receives the user ID and password transmitted by the user terminal 11, and authenticates the user. When the authentication is successful, subsequent processes are performed.

In Step S132, the information processing server 12 starts tracking a position of the user (a position of the user terminal 11). The user terminal 11 repeatedly transmits position information regarding the position of the user terminal 11 to the information processing server 12.

In Step S123, the user terminal 11 transmits, to the information processing server 12, information regarding an NFT-related specific period of time and information regarding an NFT-related specific position. Information indicating the date and time of a concert is transmitted as the information regarding an NFT-related specific period of time. Further, information indicating a location of a concert hall is transmitted as the information regarding an NFT-related specific position.

The information processing server 12 receives, in Step S133, the information transmitted by the user terminal 11, and performs, in Step S134, a process of determining a period of time and a position for providing services. The process of determining a period of time and a position for providing services is a process of determining whether the user is in a concert hall on the concert day.

When the information processing server 12 has determined that the user is in the concert hall on the concert day, the information processing server 12 transmits a user ID and position information regarding a position of the user to the service providing server 13 in Step S135.

The service providing server 13 receives, in Step S141, the information transmitted by the information processing server 12, and records therein the received information in Step S142. The position information transmitted by the user terminal 11 through the information processing server 12 is recorded in the service providing server 13 in association with the user ID. The position information regarding a position of the user terminal 11 is continuously recorded to be maintained until, for example, the provision of services is terminated.

In Step S143, the service providing server 13 starts providing guidance to guide the user to a trigger point set in the concert hall. Information regarding a screen and sound that are used to guide the user to a trigger point is transmitted to the user terminal 11.

In Step S124, the user terminal 11 receives the information transmitted by the service providing server 13, and outputs a screen and sound to guide the user to a trigger point. Guidance for a trigger point is output on the basis of the information transmitted by the service providing server 13. The user looks for a trigger point in accordance with the guidance.

The user terminal 11 performs sensing on a surrounding environment around the user in Step S125, and transmits sensor data to the information processing server 12 in Step S126. When the user having found a trigger point is alone at a location surrounded by wall surfaces in three directions, the sensor data detected in such a state is transmitted to the information processing server 12.

The information processing server 12 receives, in Step S136, the sensor data transmitted by the user terminal 11, and performs a trigger condition determining process in Step S137. Subsequent processes are processes performed when it is determined, as a result of the trigger condition determining process, that a condition for using a service is satisfied.

In Step S138, the information processing server 12 transmits, to the service providing server 13, information regarding a determination result showing that the condition for using the service is satisfied.

The service providing server 13 receives, in Step S144, the information transmitted by the information processing server 12, and provides the service to the user of the user terminal 11 in Step S145. For example, a service that allows the user to purchase an item and a service that allows the user to have a talk with his/her favorite are provided.

The user terminal 11 receives, in Step S127, content transmitted by the service providing server 13, and outputs the received content in Step S128. Accordingly, the user having been determined to satisfy the condition for using the service can use the service alone at a trigger point in the concert hall.

In Step S129, the user terminal 11 performs sensing with respect to a feeling of the user. As described above, sensing is performed with respect to the feeling by, for example, using an image captured using a camera.

In Step S130, the user terminal 11 transmits, to the service providing server 13, information indicating the feeling of the user. The feeling of the user may be specified by the service providing server 13 instead of being specified by the user terminal 11. In this case, sensor data such as an image captured using a camera and biological information detected using a biological sensor are transmitted to the service providing server 13 and used to perform sensing with respect to the feeling of the user.

The feeling of the user may be specified by the information processing server 12. In this case, sensor data such as biological information is transmitted to the information processing server 12.

The service providing server 13 receives, in

Step S146, the information transmitted by the user terminal 11, and reflects, in Step S147, the received information in the service that is being provided. When the user terminates the use of the service in the concert hall, the processing in FIG. 13 is terminated.

### Example of Application to Event That is “Grief-Healing Trip”

Next, an example of application to the case of taking a grief-healing trip as an event in a real space, is described. Different services are available for respective timings that are a timing before the event, a timing on the day of the event, and a timing after the event. A departure day and a day during a trip each correspond to the day of an event.

In this example, it is assumed that, before the day of an event, a user also gets a travel ticket created in the form of an NFT. The NFT includes information such as information regarding the user, travel days, accommodations, and transportations. The NFT serving as the travel ticket has been already linked to the dedicated application 11A. The dedicated application 11A can refer to each piece of information included in the NFT.

### Before Event

When the user satisfies a trigger condition, for example, at home, content for organizing negative memories is provided to the user as a service provided before an event. The user can work off stress, as in the case of using content for organizing negative memories, which has been described with reference to FIG. 2.

Further, the user can spend his/her days before the event while working off stress by himself/herself.

### Day of Event

The NFT serving as the travel ticket includes information regarding a travel-related specific period of time, and information regarding a travel-related specific position. For example, a period of time from a departure day to a day of returning home is set to be the specific period of time, and an area near the accommodations is set to be the specific position.

When it is determined that the user is at the specific position for the specific period of time, information such as a user ID and a current position is transmitted to the service providing server 13. For example, the NFT serving as the travel ticket also includes address information used to specify a transmission destination of the information such as a user ID and a current position. The service providing server 13 starts providing, for example, guidance that shows a route to the accommodations and a recommended spot according to a current position of the user.

Further, guidance that guides the user to a trigger point set in the accommodations is started after the user arrives in the accommodations. In accordance with the guidance, the user moves to the trigger point to be alone. This results in providing a service that allows the user to organize negative memories.

As described above, a user can also use, at a travel destination such as accommodations or a recommended spot, services provided by the service providing server 13, and this enables the user to keep on working off stress.

### After Event

When the user satisfies a trigger condition, for example, at home, a service that allows the user to be surrounded by stuff of memories of the trip is provided to the user as a service provided after the event. For example, a souvenir purchased during his/her trip and pictures taken during his/her trip are displayed on the screen of the user terminal 11. The user can feel healed, as in the case of using content that offers a state in which the user is surrounded by his/her favorites, which has been described with reference to FIG. 2.

As described above, the above-described function of providing services to a user who satisfies a trigger condition can be applied to various real events.

### Example in Which Real Item is Delivered Before Event

The example in which an item obtained by a user before an event is a travel ticket in the form of an NFT that is an electronic item, has been described. However, a real item may be delivered to a user. The real item is a physically touchable item.

Information, such as information regarding the user, travel days, accommodations, and transportations, that is included in a travel ticket and the same as information included in an NFT is recorded in, for example, a memory built in a real item. These pieces of information may be maintained by, for example, the service providing server 13 in association with an ID of the real item.

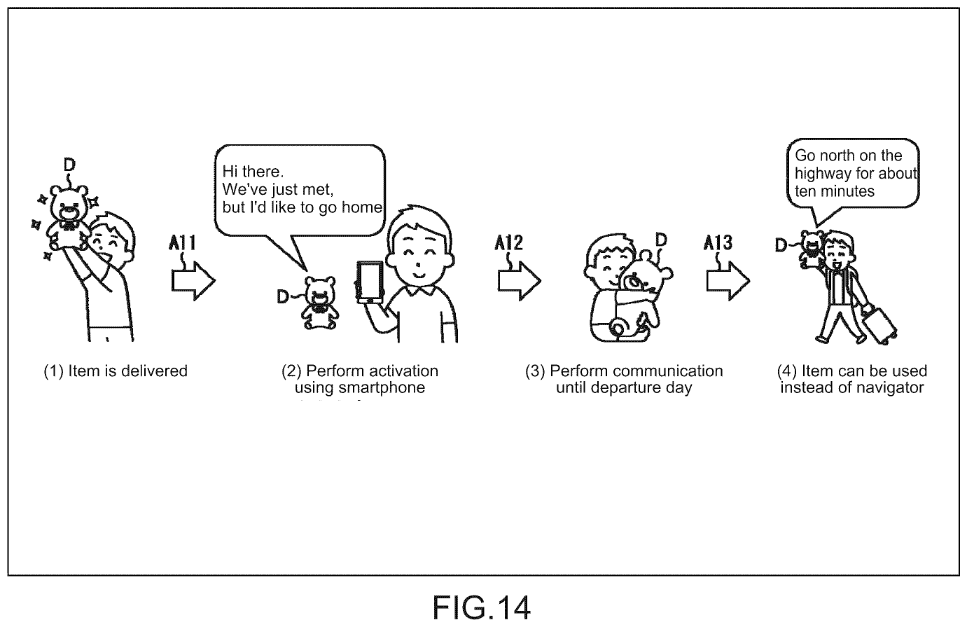

FIG. 14 illustrates an example of application to the case in which a real item is delivered before leaving on a trip.

As illustrated at a left end in FIG. 14, a real item is delivered to a user before leaving on a trip. In the example illustrated in FIG. 14, a stuffed toy D of a bear is delivered to the user. The stuffed toy D also serves as the key item described with reference to FIG. 11.

The stuffed toy D corresponding to a real item includes various sensors such as a GPS sensor (a positioning sensor) and an acceleration sensor, a wireless communication module that communicates with an external apparatus wirelessly, a speaker, and a controller that controls operations of respective structural elements. The controller controls the communication module to communicate with the user terminal 11 and the service providing server 13.

The user having received the stuffed toy D including such functions operates the user terminal 11 to activate the stuffed toy D, as indicated by an arrow A11. The activation makes it possible to, for example, detect a current position and output sound on the basis of data transmitted by the user terminal 11. For example, sound is output using a speaker of the stuffed toy D in accordance with control performed by the service providing server 13.

As indicated by an arrow A12, the user enjoys until a departure day by, for example, having a talk with the stuffed toy D. For example, information regarding a recommended spot is suggested to the user by the user having a talk with the stuffed toy D.

As indicated by an arrow A13, the user leaves on a trip on the day of departure together with the stuffed toy D. Routes to accommodations and a recommended spot are shown to the user using sound output through the speaker of the stuffed toy D.

As described above, a new type of trip starting with delivery of a real item can be provided.

Further, a task such as delivering a real item to accommodations may be set. This makes it possible to provide an experience with a story to a user through the real item. Further, the story (what the stuffed toy D shows around) may be changed dynamically on the basis of information such as a time of the day at which a user visits accommodations, weather at the time of the visit, how many times the user visited the place (the accommodations) in the past, whom the user met at the place (the accommodations), and where the user passed before arriving at the place (the accommodations).

### Configuration of Each Apparatus

Here, a configuration of each apparatus included in the information processing system 1 is described.

### Configuration of User Terminal 11

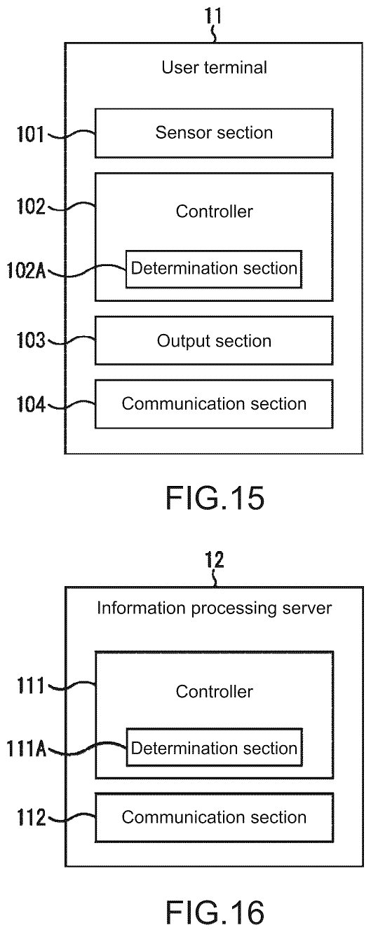

FIG. 15 is a block diagram of an example of a configuration of the user terminal 11.

The user terminal 11 includes a sensor section 101, a controller 102, an output section 103, and a communication section 104.

The sensor section 101 includes various sensors such as a camera, a mike, a ToF sensor, a positioning sensor, and an acceleration sensor. Each of the sensors included in the sensor section 101 detects a target at all times, for example, during running of the dedicated application 11A.

Sensor data that indicates a result of detection performed using each of the sensors included in the sensor section 101 is supplied to the controller 102. Examples of the sensor data output by the sensor section 101 include data of RGB images captured using the camera, data of sound, such as a voice and an environmental sound, that is detected using the mike, data of a range image obtained by detection performed using the ToF sensor, data of a current position detected using the positioning sensor, and data of acceleration detected using the acceleration sensor.

At least a portion of the sensors included in the sensor section 101 may be provided to be external to the user terminal 11. In this case, sensor data that indicates a result of detection performed using the external sensor is supplied to the controller 102.

The controller 102 includes a CPU, a ROM, and a RAM. The controller 102 executes a program such as the dedicated application 11A to control an overall operation of the user terminal 11.

For example, the controller 102 controls the communication section 104, and transmits, to the information processing server 12, sensor data supplied by the sensor section 101. The sensor data transmitted to the information processing server 12 is used for, for example, a trigger condition determining process. Further, the controller 102 acquires content that is transmitted by the information processing server 12 or the service providing server 13 to be received by the communication section 104, and controls display of an image included in the content and output of sound included in the content.

When the trigger condition determining process is performed by the user terminal 11, a determination section 102A is provided to the controller 102, as illustrated in FIG. 15. The determination section 102A includes a function of performing the trigger condition determining process on the basis of sensor data, as in the case of a determination section 111A of the information processing server 12 (FIG. 16).

The user terminal 11 including the controller 102 including the determination section 102A determines, on the basis of the sensor data, whether a trigger condition is satisfied, and when the user terminal 11 has determined that the trigger condition is satisfied, the user terminal 11 serves as an information processing apparatus that provides a user with services for which content is used.

The output section 103 includes a display such as an LCD, and a speaker. A UI screen for content is displayed on the display included in the output section 103. Further, sound and background music of content are output through the speaker. When determination of whether it is a trigger point is performed by detecting, using the mike, an echoing sound of sound output through the speaker, sound used to detect the echoing sound is also output through the speaker included in the output section 103.

The communication section 104 includes, for example, a communication module for a wireless LAN and a communication module for mobile communication such as 5G communication. The communication section 104 communicates with the information processing server 12 or the service providing server 13 under the control of the controller 102.

Note that the user terminal 11 is provided as appropriate with other structural elements such as an operation section that includes a touchscreen provided to be superimposed on the display, and a button provided to a specified position on a housing.

The processes described above are performed by the respective processing sections illustrated in FIG. 15. For example, from among the processes performed by the user terminal 11 and described with reference to the sequence illustrated in FIG. 6, the process of Step S1 corresponds to a process performed by the controller 102. The processes of Steps S2 and S4 correspond to processes performed by the controller 102 controlling the communication section 104. The process of Step S3 corresponds to a process performed by the controller 102 controlling the sensor section 101. The process of Step S5 corresponds to a process performed by the communication section 104. The process of Step S6 corresponds to a process performed by the controller 102 controlling the output section 103.

From among the processes performed by the user terminal 11 and described with reference to the sequence illustrated in FIG. 7, the process of Step S31 corresponds to a process performed by the controller 102 controlling the output section 103. The processes of Steps S32 and S34 correspond to processes performed by the controller 102 controlling the sensor section 101. The processes of Steps S33 and S35 correspond to processes performed by the controller 102 controlling the communication section 104.

From among the processes performed by the user terminal 11 and described with reference to the sequence illustrated in FIG. 12, the process of Step S101 corresponds to a process performed by the controller 102 controlling the communication section 104. The process of Step S102 corresponds to a process performed by the communication section 104.

From among the processes performed by the user terminal 11 and described with reference to the sequence illustrated in FIG. 13, the process of Step S121 corresponds to a process performed by the controller 102. The processes of Steps S122, S123, S126, and S130 correspond to processes performed by the controller 102 controlling the communication section 104. The processes of Steps S124 and S127 correspond to processes performed by the communication section 104. The processes of Steps S125 and S129 correspond to processes performed by the controller 102 controlling the sensor section 101. The process of Step S128 corresponds to a process performed by the controller 102 controlling the output section 103.

### Configuration of Information Processing Server 12

FIG. 16 is a block diagram of an example of a configuration of the information processing server 12.

The information processing server 12 includes a controller 111 and a communication section 112.

The controller 111 includes a CPU, a ROM, and a RAM. The controller 111 executes a specified program to control an overall operation of the information processing server 12. The determination section 111A is provided to the controller 111. For example, the determination section 111A acquires sensor data transmitted by the user terminal 11 and received by the communication section 112, and performs a trigger condition determining process.

The information processing server 12 including the controller 111 including the determination section 111A determines, on the basis of the sensor data, whether a trigger condition is satisfied, and when the information processing server 12 has determined that the trigger condition is satisfied, the information processing server 12 serves as an information processing apparatus that provides a user of the user terminal 11 with services for which content is used.

The communication section 112 includes, for example, a communication module for a wireless/wired LAN and a communication module for mobile communication. The communication section 112 communicates with the user terminal 11 or the service providing server 13 under the control of the controller 111.

The processes described above are performed by the respective processing sections illustrated in FIG. 16. For example, from among the processes performed by the information processing server 12 and described with reference to the sequence illustrated in FIG. 6, the processes of Steps S11 and S12 correspond to processes performed by the communication section 112. The process of Step S13 corresponds to a process performed by the determination section 111A. The process of Step S14 corresponds to a process performed by the controller 111 controlling the communication section 112.

The respective processes performed by the information processing server 12 and described with reference to the sequence illustrated in FIG. 7 correspond to processes performed by the determination section 111A.

From among the processes performed by the information processing server 12 and described with reference to the sequence illustrated in FIG. 13, the processes of Steps S131, S133, and S136 correspond to processes performed by the communication section 112. The processes of Steps S132 and S134 correspond to processes performed by the controller 111. The process of Step S137 corresponds to a process performed by the determination section 111A. The processes of Steps S135 and S138 correspond to processes performed by the controller 111 controlling the communication section 112.

### Configuration of Service Providing Server 13

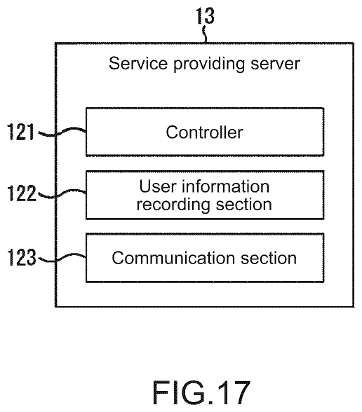

FIG. 17 is a block diagram of an example of a configuration of the service providing server 13.

The service providing server 13 includes a controller 121, a user information recording section 122, and a communication section 123.

The controller 121 includes a CPU, a ROM, and a RAM. The controller 121 executes a specified program to control an overall operation of the service providing server 13.

The user information recording section 122 includes recording media such as a hard disk or an SSD. The user information recording section 122 records therein information regarding a user who uses the information processing system 1. For example, a user ID and position information regarding a position of the user are recorded as the information regarding the user. For example, content related to services may be recorded in the user information recording section 122.

The communication section 123 includes, for example, a communication module for a wireless/wired LAN and a communication module for mobile communication. The communication section 123 communicates with the user terminal 11 or the information processing server 12 under the control of the controller 121.

The processes described above are performed by the respective processing sections illustrated in FIG. 17. For example, from among the processes performed by the service providing server 13 and described with reference to the sequence illustrated in FIG. 12, the process of Step S111 corresponds to a process performed by the communication section 123. The process of Step S112 corresponds to a process performed by the controller 121. The process of Step S113 corresponds to a process performed by the controller 121 controlling the communication section 123.

From among the processes performed by the service providing server 13 and described with reference to the sequence illustrated in FIG. 13, the processes of Steps S141, S144, and S146 correspond to processes performed by the communication section 123. The process of Step S142 corresponds to a process performed by the user information recording section 122. The processes of Steps S143, S145, and S147 correspond to processes performed by the controller 121 controlling the communication section 123.

### Modifications

### Examples of Trigger Points

The example in which a location surrounded by wall surfaces in three directions is set to be a trigger point has been described above. However, a location having another context may be set to be a trigger point. A location, such as a location in a car, a location surrounded by sea, or a center portion of a square of a park, that has any context may be set to be a trigger point.

Data related to work may be available only when a trigger condition is satisfied. Risks such as leak of information can be reduced since the data is available only when a user is alone at a location surrounded by wall surfaces.

The method using a directional speaker and a directional mike has been described as an example of a method for specifying a surrounding environment around a user on the basis of an echoing sound. However, one of the speaker and the mike may be nondirectional or both may be nondirectional. The surrounding environment around a user can be specified using a model created by machine learning that uses, as training data, data acquired in the form of an echoing sound at a specific location that is surrounded by wall surfaces in at least three directions with respect to the user, as illustrated in A and B of FIG. 4, the acquisition of the data being performed using the mike. Thus, at least one of the speaker or the mike may be nondirectional.

The example in which content using sound and an image such as a video or a still image is provided as content related to services, has been described above. However, another type of content such as AR content or VR content may be provided. At least one of content of sound, content of an image, AR content, or VR content may be provided. The type of content may be changed according to the type of device used as the user terminal 11.

For example, various objects in a virtual space are presented on the screen in A of FIG. 3. However, instead of the objects being presented on the screen, sound may be output to arrange as if the objects were talking to a user through earphones or a headphone. In this case, sound can be converted into sound desired by a user, using a sound synthesis technology. Further, using a stereophonic sound technology, sound may be output to arrange as if objects were whispering in user's ear.

### Regarding Program

The series of processes described above can be performed using hardware or software. When the series of processes is performed using software, a program included in the software is installed on, for example, a computer incorporated into dedicated hardware or a general-purpose personal computer.

The program to be installed is provided by being recorded in a removable medium such as an optical disk (such as a compact disc-read only memory (CD-ROM) or a digital versatile disc (DVD)) or a semiconductor memory. Further, the program may be provided via a wired or wireless transmission medium such as a local area network, the Internet, or digital broadcasting. The program may be installed on a ROM or a storage in advance.

The program executed by the computer may be a program in which processes are chronologically performed in the order of the description herein, or may be a program in which processes are performed in parallel or a process is performed at a necessary timing such as a timing of calling.

The system as used herein refers to a collection of a plurality of components (such as apparatuses and modules (parts)) and it does not matter whether all of the components are in a single housing. Thus, a plurality of apparatuses accommodated in separate housings and connected to one another via a network, and a single apparatus in which a plurality of modules is accommodated in a single housing are both systems.

The effects described herein are not limitative but are merely illustrative, and other effects may be provided.

The embodiments of the present technology are not limited to the examples described above, and various modifications may be made thereto without departing from the scope of the present technology.

For example, the present technology may have a configuration of cloud computing in which a single function is shared to be cooperatively processed by a plurality of apparatuses via a network.

Further, the respective steps described using the flowcharts described above may be performed by a single apparatus, or may be shared to be performed by a plurality of apparatuses.

Furthermore, when a single step includes a plurality of processes, the plurality of processes included in the single step may be performed by a single apparatus, or may be shared to be performed by a plurality of apparatuses.

### Example of Combination of Configurations

The present technology may also take the following configurations.

(1) An information processing apparatus, including
a controller
   that determines a state of a user on the basis of sensor data acquired using a sensor situated around the user, and
   that provides the user with a specific service for which content is used, the provision being performed when the user is alone at a specific location surrounded by wall surfaces in at least three directions.

(2) The information processing apparatus according to (1), in which
the controller determines the state of the user on the basis of at least one of audio data acquired as the sensor data, or image data acquired as the sensor data.

(3) The information processing apparatus according to (1) or (2), in which
the wall surfaces in the three directions are formed of a wall surface in a first direction, a wall surface in a second direction substantially orthogonal to the wall surface in the first direction, and a third wall surface that faces the wall surface in the second direction.

(4) The information processing apparatus according to (1) or (2), in which
the wall surfaces in the three directions are formed of a continuous curved surface.

(5) The information processing apparatus according to any one of (2) to (4), in which
the controller determines the state of the user on the basis of the audio data acquired by detecting an echoing sound of an audio signal output through a speaker situated around the user.

(6) The information processing apparatus according to (5), in which
the controller determines that the user is at the specific location, on the basis of the audio data acquired by detecting the echoing sound coming from a direction that corresponds to a direction of directivity of the speaker.

(7) The information processing apparatus according to (6), in which
the controller determines that the user is alone by determining presence or absence of a voice of a person on the basis of the audio data indicating the echoing sound collected using a microphone situated around the user, and by determining presence or absence of a person on the basis of the image data of an image captured using a camera situated around the user.

(8) The information processing apparatus according to any one of (1) to (7), in which
when the user is at a position related to a specific event for a period of time related to the specific event, the controller transmits identification information regarding the user and position information regarding a position of the user to a specific address through a communication section, and provides the specific service for which the content received by the communication section is used.

(9) The information processing apparatus according to (8), in which
when the controller determines, on the basis of a non-fungible token, that the user is holding the token at the position related to the specific event for the period of time related to the specific event, the controller transmits the identification information regarding the user and the position information regarding the position of the user to a service server that corresponds to the specific address indicated by the token, the token indicating at least the position related to the specific event and the period of time related to the specific event.

(10) The information processing apparatus according to (9), in which
during the provision of the service, the service server records therein position information regarding a position of an apparatus that provides the service directly to the user, and

on the basis of information transmitted by the service server, the controller outputs guidance that guides the user to the specific location.

(11) The information processing apparatus according to (9) or (10), in which
the service server discloses information regarding a person to another person, the person being at the position related to the specific event for the period of time related to the specific event, and
the controller outputs information regarding a person other than the user on the basis of information transmitted by the service server.

(12) The information processing apparatus according to any one of (1) to (11), in which
the controller provides the specific service for which at least one of sound content, AR content, or VR content is used.

(13) An information processing method that is performed by an information processing apparatus, the information processing method including:
determining a state of a user on the basis of sensor data acquired using a sensor situated around the user; and
providing the user with a specific service for which content is used, the provision being performed when the user is alone at a specific location surrounded by wall surfaces in at least three directions.

(14) A program that causes a computer to perform a process including:
determining a state of a user on the basis of sensor data acquired using a sensor situated around the user; and
providing the user with a specific service for which content is used, the provision being performed when the user is alone at a specific location surrounded by wall surfaces in at least three directions.

### Reference Signs List

1 information processing system
11 user terminal
11A dedicated application
12 information processing server
13 service providing server
101 sensor section
102 controller
102A determination section
103 output section
104 communication section
111 controller
111A determination section
112 communication section
121 controller
122 user information recording section
123 communication section

1. An information processing apparatus, comprising
a controller
that determines a state of a user on a basis of sensor data acquired using a sensor situated around the user, and
that provides the user with a specific service for which content is used, the provision being performed when the user is alone at a specific location surrounded by wall surfaces in at least three directions.

2. The information processing apparatus according to claim 1, wherein
the controller determines the state of the user on a basis of at least one of audio data acquired as the sensor data, or image data acquired as the sensor data.

3. The information processing apparatus according to claim 1, wherein
the wall surfaces in the three directions are formed of a wall surface in a first direction, a wall surface in a second direction substantially orthogonal to the wall surface in the first direction, and a third wall surface that faces the wall surface in the second direction.

4. The information processing apparatus according to claim 1, wherein
the wall surfaces in the three directions are formed of a continuous curved surface.

5. The information processing apparatus according to claim 2, wherein
the controller determines the state of the user on a basis of the audio data acquired by detecting an echoing sound of an audio signal output through a speaker situated around the user.

6. The information processing apparatus according to claim 5, wherein
the controller determines that the user is at the specific location, on a basis of the audio data acquired by detecting the echoing sound coming from a direction that corresponds to a direction of directivity of the speaker.

7. The information processing apparatus according to claim 6, wherein
the controller determines that the user is alone by determining presence or absence of a voice of a person on a basis of the audio data indicating the echoing sound collected using a microphone situated around the user, and by determining presence or absence of a person on a basis of the image data of an image captured using a camera situated around the user.

8. The information processing apparatus according to claim 1, wherein
when the user is at a position related to a specific event for a period of time related to the specific event, the controller transmits identification information regarding the user and position information regarding a position of the user to a specific address through a communication section, and provides the specific service for which the content received by the communication section is used.

9. The information processing apparatus according to claim 8, wherein
when the controller determines, on a basis of a non-fungible token, that the user is holding the token at the position related to the specific event for the period of time related to the specific event, the controller transmits the identification information regarding the user and the position information regarding the position of the user to a service server that corresponds to the specific address indicated by the token, the token indicating at least the position related to the specific event and the period of time related to the specific event.

10. The information processing apparatus according to claim 9, wherein
during the provision of the service, the service server records therein position information regarding a position of an apparatus that provides the service directly to the user, and
on a basis of information transmitted by the service server, the controller outputs guidance that guides the user to the specific location.

11. The information processing apparatus according to claim 9, wherein
the service server discloses information regarding a person to another person, the person being at the position related to the specific event for the period of time related to the specific event, and
the controller outputs information regarding a person other than the user on a basis of information transmitted by the service server.

12. The information processing apparatus according to claim 1, wherein
the controller provides the specific service for which at least one of sound content, AR content, or VR content is used.

13. An information processing method that is performed by an information processing apparatus, the information processing method comprising:
determining a state of a user on a basis of sensor data acquired using a sensor situated around the user; and
providing the user with a specific service for which content is used, the provision being performed when the user is alone at a specific location surrounded by wall surfaces in at least three directions.

14. A program that causes a computer to perform a process comprising:
determining a state of a user on a basis of sensor data acquired using a sensor situated around the user; and
providing the user with a specific service for which content is used, the provision being performed when the user is alone at a specific location surrounded by wall surfaces in at least three directions.
